(19) United States
(12) Patent Application Publication
(10) Pub. No.: US 2025/0094564 A1
(43) Pub. Date: Mar. 20, 2025

(54) Secure Exclaves

(71) Applicant: Apple Inc., Cupertino, CA (US)

(72) Inventors: Peter A. Lisherness, Los Gatos, CA (US); Assaf Menachem, Hod Hasharon (IL); Assaf Metuki, Herut (IL); Benjamin Biron, Saratoga, CA (US); D J Capelis, San Francisco, CA (US); Husam Khashiboun, Cupertino, CA (US); Jacques Fortier, San Francisco, CA (US)

(21) Appl. No.: 18/790,765

(22) Filed: Jul. 31, 2024

Related U.S. Application Data
(60) Provisional application No. 63/584,037, filed on Sep. 20, 2023.
(60) Provisional application No. 63/584,032, filed on Sep. 20, 2023.
(60) Provisional application No. 63/584,029, filed on Sep. 20, 2023.

(51) Int. Cl. G06F 21/53; G06F 21/62

(52) U.S. Cl. CPC G06F 21/53; G06F 21/6218; G06F 2221/033

(57) ABSTRACT

Techniques are disclosed relating to securing hardware accelerators used by a computing device. In some embodiments, a computing device includes a sensor and sensor processor circuitry coupled to the sensor. The sensor processor circuitry is configured to process sensor data received from a sensor of the computing device. In response to a first indication that a first consumer is trustworthy, the sensor processor circuitry is configured to provide a first data set of the processed sensor data to the first consumer. In response to a second indication that a second consumer is untrustworthy, the sensor processor circuitry is configured to negotiate one or more conditions in which the second consumer is permitted to receive a second data set of the processed sensor data.

The present application claims priority to U.S. Prov. Appl. Nos. 63/584,029, 63/584,032, 63/584,037, entitled “Secure Exclaves,” filed Sep. 20, 2023; the disclosures of each of the above-referenced applications are incorporated by reference herein in their entireties.

### BACKGROUND

### Technical Field

This disclosure relates generally to computing devices, and, more specifically, to improving the security of computing devices.

### Description of the Related Art

Computing devices, such as computers, mobile phones, tablets, or other devices, can often store large amounts of sensitive data. For example, a user's mobile phone might store contact information of friends and family, photographs, text messages, email, passwords, financial information, etc. This sensitive data may also include various sensor data provided by sensors included in devices such as one or more cameras, microphones, location sensors, biometric sensors, health sensors, etc. In order to prevent unauthorized access to this data, devices may employ various security techniques.

### BRIEF DESCRIPTION OF THE DRAWINGS

FIG. 1 is a block diagram illustrating an example of a device that supports secure exclaves.

FIG. 2 is a block diagram illustrating an example of a software architecture of the device.

FIG. 3A-3C are block diagrams illustrating examples of data flows of between sensors and applications of the device.

FIG. 4 is a diagram illustrating an example of a display unit implementing a secure exclave.

FIG. 5 is a diagram illustrating an example of an image signal processor implementing a secure exclave.

FIG. 6 is a diagram illustrating an example of an audio unit implementing a secure exclave.

FIG. 7 is a diagram illustrating an example of a neural engine implementing a secure exclave.

FIG. 8 is a diagram illustrating an example of a graphics processing unit implementing a secure exclave.

FIGS. 9A-11B are flow diagrams illustrating examples of methods implementing functionality described herein.

FIG. 12 is a block diagram illustrating an example computing device implementing functionality described herein.

FIG. 13 is a diagram illustrating example applications for systems and devices implementing functionality described herein.

FIG. 14 is a block diagram illustrating an example computer-readable medium that stores circuit design information for implementing devices having functionality described herein.

### DETAILED DESCRIPTION

Protection of sensitive data has traditionally been the prerogative of 1) particular software (e.g., an operating system/kernel) running on a device's central processing unit (CPU) or 2) specialized hardware (sometimes referred to as “enclaves”) that employ strong separation techniques to prevent external entities (e.g., executing processes, the CPU, etc.) from being able to directly access internal data. While these enforcement mechanisms can provide a secure environment for sensitive data, this secure environment is typically confined to a particular region of a device controlled by the enforcement mechanism and does not extend to other regions outside of the enforcement mechanism's control, which can present a potential attack vector. For example, an operating system may be able prevent a first process from being able to access sensitive data of a second process while both processes execute on a device's CPU-a region controlled by the operating system. The first process, however, may be able to circumvent this enforcement, by accessing components external to the CPU such as a device's graphics process unit (GPU) or other hardware accelerators.

The present disclosure describes embodiments in which a secure environment is extended by implementing secure exclaves. As will be discussed in various embodiments, a computing device can include one or more processors configured to co-execute trusted processes and untrusted processes in an isolated manner that includes implementing a secure environment in which a set of security criteria is enforced for data of the trusted processes. The computing device can include multiple heterogenous hardware accelerators (e.g., GPUs, neural engines, peripheral accelerators, etc.) configured to implement exclaves of the secure environment that extend enforcement of one or more of the set of security criteria within the hardware accelerators for data distributed to them for performance of tasks associated with the trusted processes. In many instances, extending a secure environment in this manner can reduce the attack surface for obtaining access to sensitive data. It can also allow for greater hardware resources to be available for sensitive tasks when using unsecured resources is an undesirable option.

As one example discussed below in some embodiments, a computing device may have a sensor that collects sensitive data, such as a camera, microphone, etc. Sensor processor circuitry of the computing device can process this sensor data and negotiate one or more conditions in which an untrusted consumer is permitted to receive the processed sensor data. For example, access to the sensitive data may be permitted as along as a user is notified of the sensor's use. In some embodiments, a user interface hardware accelerator implementing an exclave of the secure environment processes received data to produce an output for a user interface of the computing device such as a display, speaker, etc. The hardware accelerator can receive, from a source in the secure environment, an indication that the sensor has been activated and, prior to presenting the output via the user interface, insert, into the output, an artifact/indicator (e.g., pixels, a sound, etc.) of the component being activated. In some embodiments, the user interface pipeline circuitry can further extract, prior to presenting the output, data corresponding to where the indicator was inserted into the output and provide the data to a destination in the secure environment for analysis to determine whether the indicator remains inserted into the output being presented. If the indicator is not present in the output, the secure environment can notify an exclave implemented by the sensor processor circuitry to prevent access to the sensor data. In using one or more exclaves to protect insertion and analysis of this indicator, the computing device can make it more difficult for malicious software executing outside of the secure environment to activate the sensor and interfere with the corresponding user activity indicator.

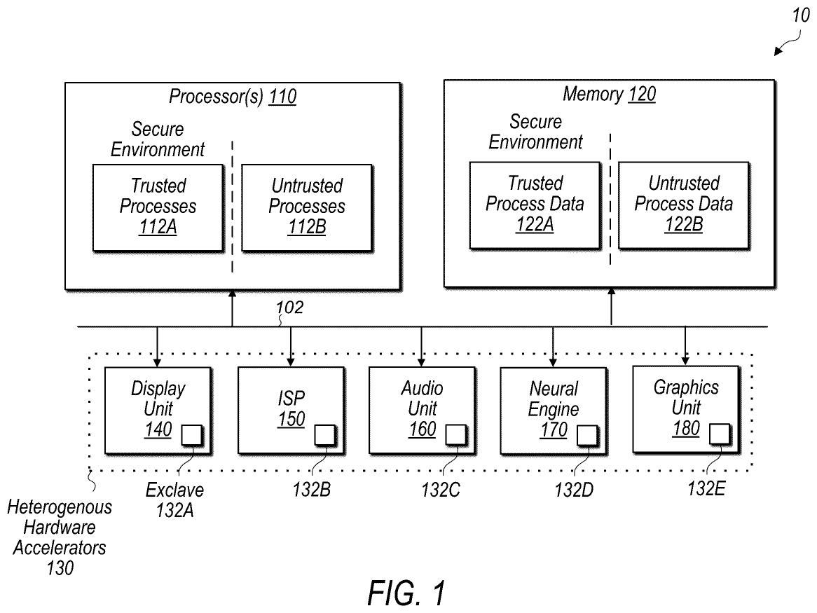

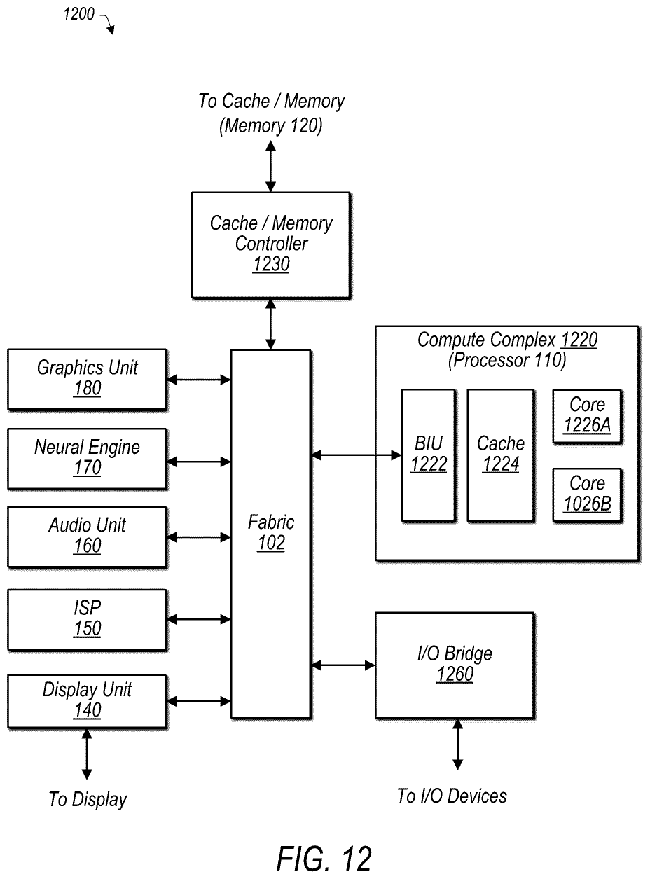

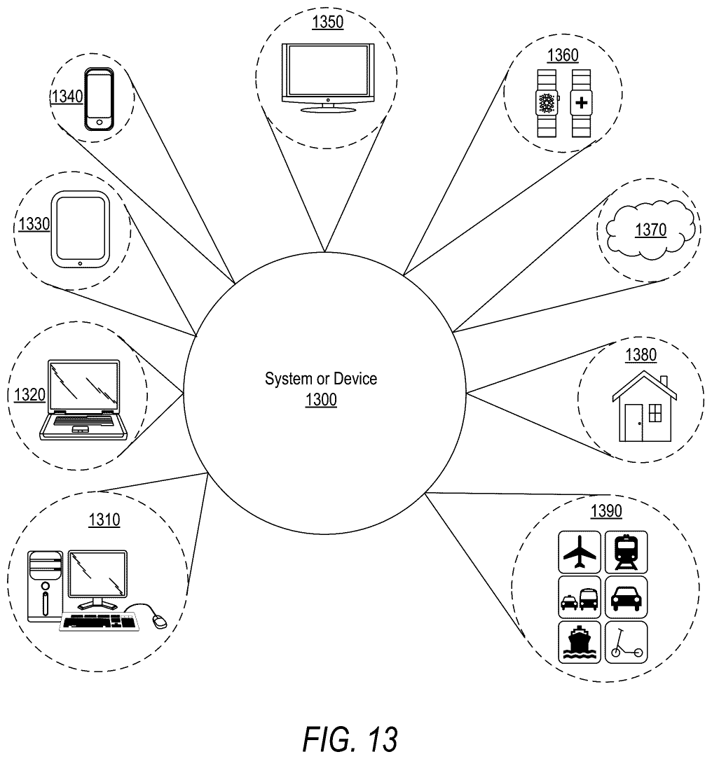

Turning now to FIG. 1, a block diagram of a computing device 10 supporting exclaves is depicted. Device 10 may correspond to any suitable computing device such as a desktop computer, laptop, tablet, mobile phone, server, or any other ones of the devices discussed below with respect to FIG. 13. In the illustrated embodiment, device 10 includes one or more processors 110, memory 120, and heterogenous hardware accelerators 130 coupled together via a fabric 102. Heterogenous hardware accelerators 130 include a display unit 140, image signal processor (ISP) 150, audio unit 160, neural engine 170, and graphics unit 180. In other embodiments, device 10 may be implemented differently than shown—e.g., device 10 may include different accelerators 130, additional components such as discussed with FIG. 12, etc.

Processors 110 are processors (e.g., CPUs) configured to execute program instructions of various processes 112 to perform various operations. As shown, these processes 112 include trusted processes 112A, which may include processes traditionally associated with kernel space such as drivers, kernel services, etc. Trusted processes 112A may also include processes that operate on sensitive data such as user data, sensor data, etc. Processes 112 also include untrusted processes 112B, which may include processes traditionally associated with user space such as user applications, office suites, games, etc. In some embodiments, trusted processes 112A are believed to be more trustworthy than untrusted processes 112B because processes 112A may be provided by a trusted source (e.g., device manufacturer), may have a verifiable integrity (e.g., using digital signatures), may be designed to have a reduced attack surface, may be afforded a greater level of security protections, etc.

In order to improve the security of device 10 in various embodiments, processors 110 are configured to co-execute trusted processes 112A and untrusted processes 112B in an isolated manner that includes implementing a secure environment in which a set of security criteria is enforced. These criteria may define how trusted process data 122A is maintained for trusted processes 112A (as well as untrusted process data 122B for untrusted processes 112B in some embodiments). For example, untrusted processes 112B may be barred from accessing regions of memory 120 storing trusted process data 122A. These criteria may also define what resources are permitted (and under what conditions) to access trusted process data 122A and interface with processes 112A. These criteria may also define what resources (e.g., cameras, microphones, location sensors, motion sensors, health tracking sensors, etc.) are accessible (and under what conditions) to untrusted processes 112B. These criteria may define what execution privileges can be assigned to processes 112A and 112B. These criteria may also define the conditions/contexts in which trusted process data 112A is permitted to flow from the secure environment to untrusted processes 112B (or other untrusted destinations).

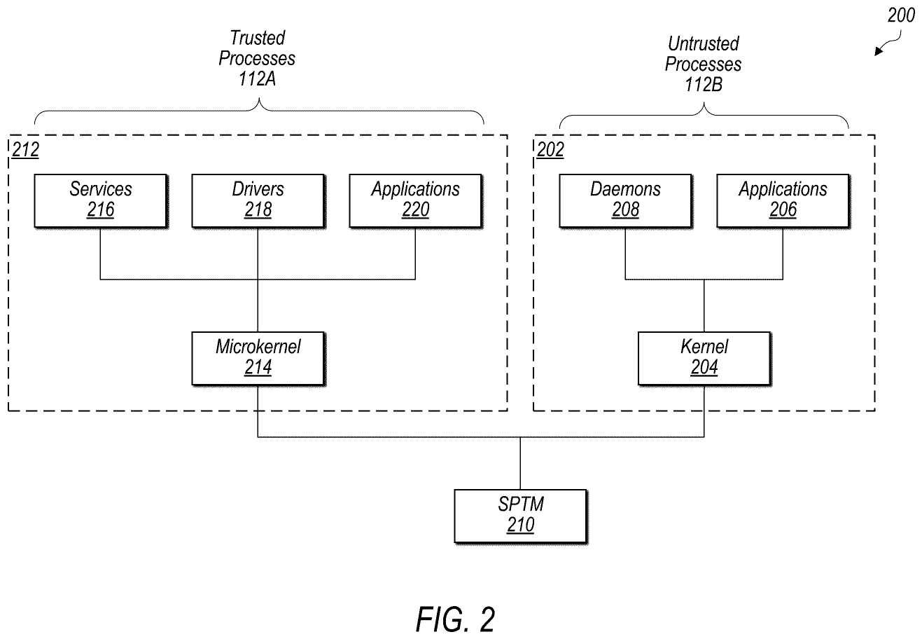

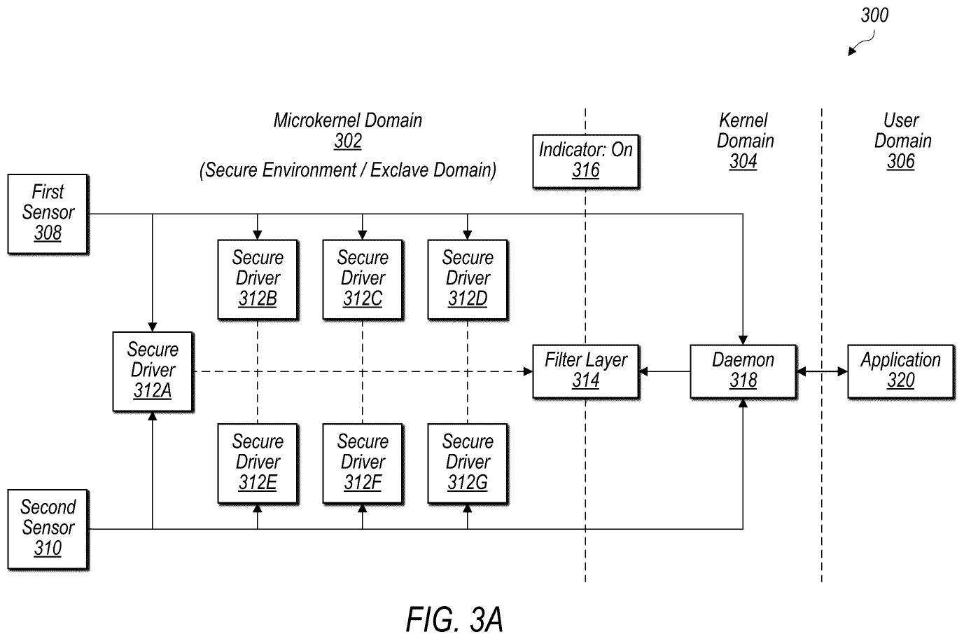

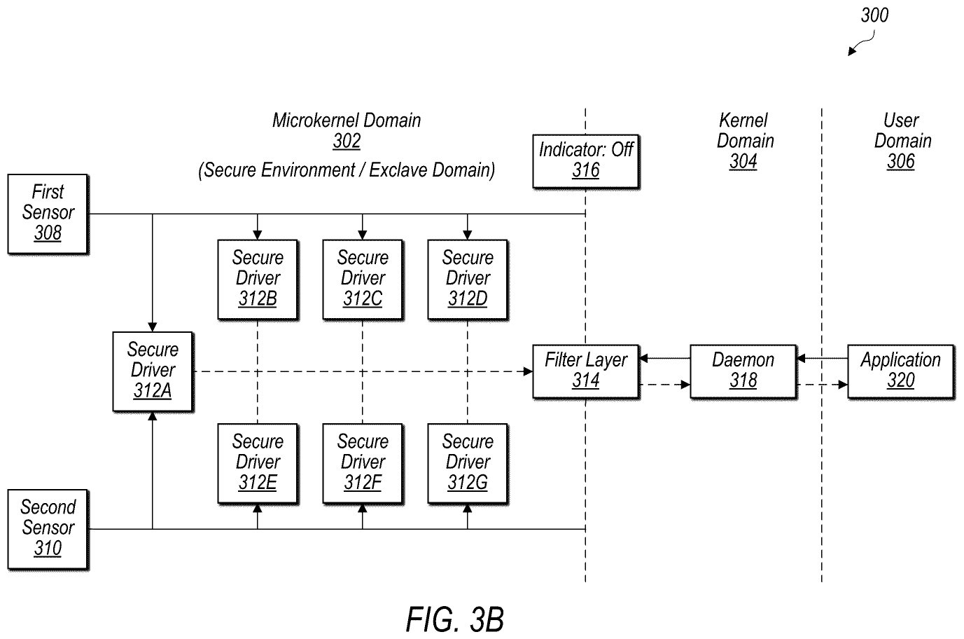

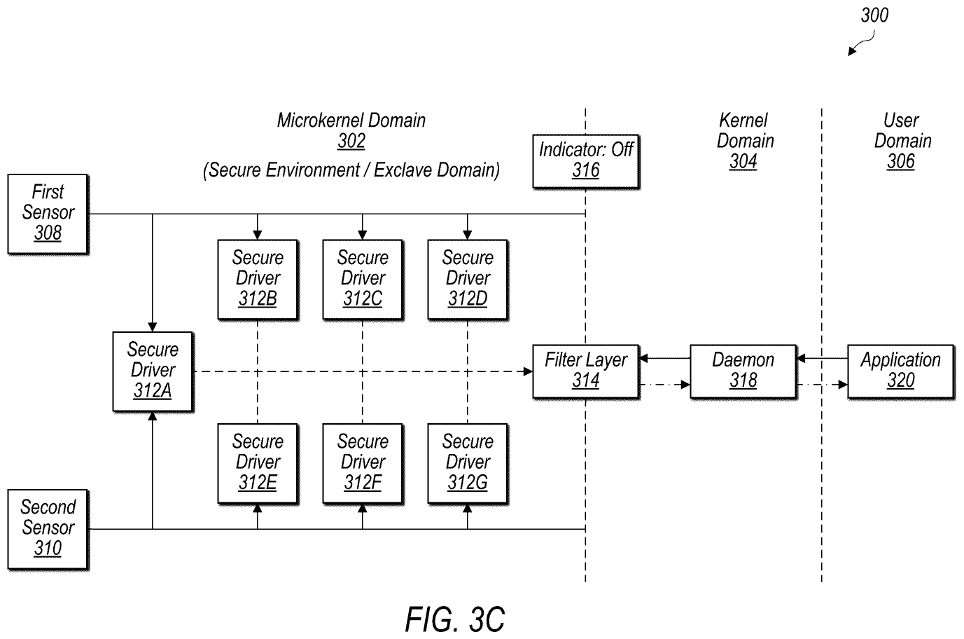

Processors 110 may implement the secure environment using any of various techniques. In some embodiments, processors 110 are configured to execute processes 112A in a privileged execution mode (ring 2 or lower) that is not available to untrusted processes 112B. Processors 110 can also segregate memory 120 and prevent memory access from untrusted processes 112B to regions associated with the secure environment. As will be described with FIGS. 2-3C, processors 110 can further employ a software architecture in which trusted processes 112A and untrusted processes 112B execute on top of separate operating systems, which can use a filter layer to control the flow of data between processes 112. In some embodiments, these operating systems also implement paravirtualization in which the operating systems execute within separate containers, which may reside on top of a hypervisor.

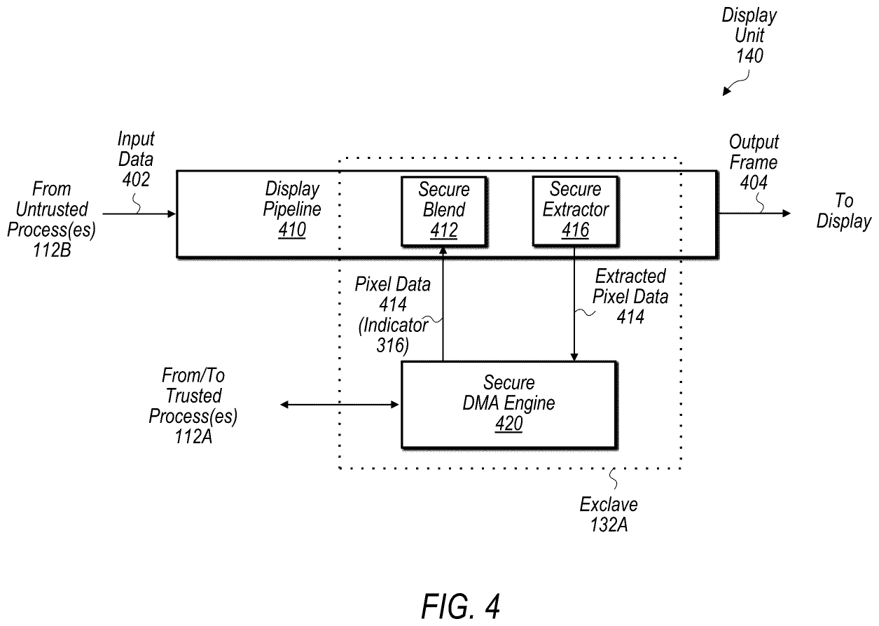

In some instances, particular tasks requested by processes 112 may benefit from the use of hardware accelerators 130 designed to perform particular tasks. As will be discussed with FIGS. 4-8, display unit 140 can perform various tasks used to produce frames output by a display. Image signal processor (ISP) 150 can perform various tasks to process sensor data received from a camera. Audio unit 160 can perform various tasks to process input audio signals from a microphone and/or output audio signals for speakers. Neural engine 170 can perform various tasks related machine learning. Graphics unit 180 can perform various graphical processing tasks. As noted above, however, a challenge with permitting trusted processes 112A to use hardware accelerators 130 is that they can present a potential attack vector for untrusted processes 112B to gain access to the secure environment.

To prevent these types of circumventions in various embodiments, hardware accelerators 130 are configured to implement exclaves 132 of the secure environment that extend enforcement of one or more security criteria within hardware accelerators 130. As will be described in greater detail below, accelerators 130 can implement exclaves 132 using a variety of techniques. For example, accelerators 130 can restrict tasks associated with untrusted processes 112B from accessing regions of memory 120 assigned to trusted processes 112A. In some embodiments, to implement this restriction, one or more hardware accelerators 130 store virtual-to-physical address translations for memory regions assigned to trusted processes 112A and for memory regions assigned to untrusted processes 112B and prevents tasks associated with untrusted processes 112B from accessing virtual-to-physical address translations for the memory regions assigned to trusted processes 112A. In some embodiments in which an accelerator 130 does not access memory using virtual addresses, the accelerator 130 can maintain a table identifying the memory regions (e.g., as defined by their physical addresses) assigned to trusted processes 112A and memory regions assigned to untrusted processes 112B and perform memory accesses in accordance with the table. In various embodiments, hardware accelerators 130 include additional circuitry to physically isolate the distributed data 122A associated with trusted processes 112A from distributed data 122B associated with the untrusted processes 112B. In some embodiments, this circuitry can include additional pipelines (or additional pipeline stages) configured to perform tasks associated with the trusted processes 112A and isolate those tasks from those associated with untrusted processes 112B. In some embodiment, this circuitry can include additional data buffers configured to store trusted data 122A distributed from memory 120 for performance of tasks associated with trusted processes 112A. In some embodiments, one or more accelerators 130 include cutoff switches to enable or disable data paths providing data to untrusted process 112 based on one or more security criteria being satisfied.

As one exemplary use case, a processor 110 may execute a trusted process 112A for identifying utterance of a trigger word (e.g., “Hey Siri”) to activate a voice assistant implemented by an untrusted process 112B. An exclave 132C implemented by audio unit 160 may process input audio received from a microphone of device 10 and provide the processed audio data to the trusted process 112A, which is permitted to access the audio data as the process 112A is in the secure environment. Audio unit 160, however, may initially prevent this audio data from leaving exclave 132C for the untrusted voice assistant process 112B but negotiate one or more conditions in which the audio data is permitted to leave the secure environment such as 1) trusted process 112A indicating that the trigger word has been detected and 2) receiving confirmation that the user is being notified about the microphone being in use.

Other examples using exclaves 132 in hardware accelerators 130 will be discussed in greater detail with FIGS. 4-8. A software architecture used by processors 110 to maintain isolation of trusted and untrusted processes 112 will be discussed next with FIGS. 2-3C.

Turning now to FIG. 2, a block diagram of a software architecture 200 of device 10 is depicted. As illustrated, device 10 includes two operating systems: a first operating system 202 and a second operating system 212. In some examples, an operating system, after being initially loaded into device 10 by a boot program, manages processes and/or applications executing on device 10. In examples with multiple operating systems, each operating system manages its own processes and/or applications. It should be recognized that more or fewer operating systems can be included in device 10 and perform techniques described herein.

As illustrated in FIG. 2, first operating system 202 includes kernel 204, applications 206, and daemons 208. In some examples, kernel 204 is a portion of first operating system 202 that is maintained in memory corresponding to first operating system 202 and/or facilitates interactions between software and hardware components corresponding to first operating system 202. For example, kernel 204 can control hardware resources (e.g., I/O devices and/or memory) via device drivers, arbitrate conflicts between processes concerning such resources, and/or optimize utilization of common resources (e.g., CPU and/or cache usage, file systems, and/or network sockets). In some examples, applications 206 includes programs that are run by a user to perform a specific task or service. In some examples, daemons 208 include background processes that are run by kernel 204 to perform a specific task or service for applications 206, kernel 204, and/or first operating system 202.

As illustrated in FIG. 2, second operating system 212 includes microkernel 214, services 216, drivers 218, and applications 220. Similar to kernel 204, in some examples, microkernel 214 is a portion of second operating system 212 that is maintained in memory corresponding to second operating system 212 and/or facilitates interactions between software and hardware components corresponding to first operating system 202. In some examples, microkernel 214 provides less functionality as compared to kernel 204. For example, microkernel 214 can support process scheduling while other services, such as memory management and drivers to interact with hardware, can be supported by other processes (e.g., services 216 and drivers 218). In some examples, applications 220 includes programs that are run via second operating system 212 to perform a specific task or service.

As mentioned above, each of the two operating systems includes a kernel (e.g., kernel 204 for first operating system 202 and microkernel 214 for second operating system 212). It should be recognized that the use of the terms “kernel” and “microkernel” is used for exemplary purposes and either or both could be a different type of kernel in some examples described herein. For example, microkernel 214 and/or kernel 204 can be a monolithic kernel, a microkernel, a hybrid kernel, a nano kernel, or an exo kernel.

In some examples, the two operating systems of device 10 described above operate at least partially independently from each other, though both using an overlapping portion of resources of device 10 (e.g., one or more processors, memory, I/O devices, and/or I/O interfaces). In some examples, first operating system 202 operates in a normal execution mode, including execution of one or more applications (e.g., applications 206) installed and/or stored on device 10. In some examples, the one or more applications are unable to directly communicate with second operating system 212 (e.g., and/or a component of second operation system 212) and instead communicate with second operating system 212 via one or more system processes of first operating system 202, such as kernel 204 of first operating system 202 and/or a daemon of daemons 208 of first operating system 202.

In some examples, the two operating systems of device 10 described above are separated and/or isolated from each other via an isolation manager. The isolation manager manages interactions between the two operating systems 202 and second operating system 212. For example, the isolation manager can provide portions of memory and/or access to processors for an operating system during execution. For another example, the isolation manager can provide an interface for the two operating system to communicate with each other. In some examples, the isolation manager identifies what executes in a guarded mode and what executes in a regular execution mode and provides access to particular resources based on which mode is currently being used. As illustrated in FIG. 2, an example of the isolation manager is a secure page table monitor (SPTM) 210. In some examples, SPTM 210 is in communication with first operating system 202 (e.g., via kernel 204 and/or a different process of first operating system 202) and second operating system 212 (e.g., via microkernel 214 and/or a different process of second operating system 212). In such examples, SPTM 210 can be used by first operating system 202 and/or second operating system 212 to receive identification of (e.g., assignment of) and/or access memory of device 10. It should be recognized that other types of components can be used to provide separation and/or isolation for the two operating systems.

FIGS. 3A-3C are block diagrams illustrating flow of data between first sensor 308 and/or second sensor 310 and an application 320 of a device 10 in accordance with some examples. Each of the block diagrams of FIGS. 3A-3C are separated into three domains: microkernel domain 302 (corresponding to the secure environment/exclave domain), kernel domain 304, and user domain 306. In some examples, microkernel domain 302 corresponds to operations managed and/or performed in a guarded mode, such as performed by second operating system 212 in FIG. 2. In some examples, kernel domain 304 corresponds to operations managed and/or performed by a system component of first operating system 202 in FIG. 2 (e.g., a process of kernel 204 and/or a daemon of daemons 208). In some examples, user domain 306 corresponds to operations managed and/or performed by an application (e.g., a non-system process) of first operating system 202 in FIG. 2 (e.g., an application of applications 206). In some examples, kernel domain 304 and/or user domain 306 operate in a regular execution mode, as opposed to a guarded mode described above with respect to microkernel domain 302.

Turning now to FIG. 3A, a block diagram illustrates flow 300 of sensor data from one or more sensors (e.g., first sensor 308 and/or second sensor 310) through a filter layer 314 and a daemon 318 to an application 320.

As mentioned above, in some examples, first sensor 308 and/or second sensor 310 include a microphone, a touch-sensitive surface, a camera, a heart rate monitor, a step counter, a depth sensor, a motion sensor, a magnetic sensor, and/or a gyroscope. For example, first sensor 308 can be a camera, and application 320 can be a photo application that is requesting an image from first sensor 308 via daemon 318 and filter layer 314. In such an example, daemon 318 and/or filter layer 314 can determine whether indicator 316 is on (e.g., active) before allowing the request to be fulfilled (and, in some examples, the request would not be fulfilled when indicator 316 is not on).

At FIG. 3A, the flow includes application 320 sending a request for sensor information (e.g., sensor data and/or metadata corresponding to sensor data) to daemon 318. In some examples, after daemon 318 receives the request, daemon 318 determines a current context of device 10 (e.g., a location of device 10, what an output device in communication with device 10 is currently outputting, whether an output device in communication with device 10 is currently outputting, what an input device in communication with device 10 is currently detecting, whether an input device in communication with device 10 is currently detecting, what processes and/or applications are currently executing on device 10, whether a process and/or application is currently executing on device 10, whether a process and/or application is currently a background or foreground process on device 10, whether device 10 is currently in communication with another device and/or a particular device different from device 10, what a sensor in communication with output device 10 is currently detecting sensor data, whether a particular sensor in communication with output device 10 is currently detecting sensor data, and/or a current time of day) and, based on the current context, determines what type of data to request and/or whether to request sensor information from filter layer 314 (e.g., different contexts can cause different types of data to be requested or different types of data can cause daemon 318 to either send or not send a request for sensor information to filter layer 314). For example, daemon 318 can determine whether indicator 316 is on (e.g., active) (e.g., the current context of device 10) and, in response to determining that indicator 316 is on, send a request for sensor information to filter layer 314. In some examples, the request for sensor information includes an indication of a sensor, a type of sensor, and/or a type of sensor information being requested. For example, the request for sensor information can include a request for an image from a camera. In other examples, daemon 318 sends the request for sensor information to filter layer 314 without determining the current context of device 10, leaving such determinations to filter layer 314.

At FIG. 3A, first sensor 308 and second sensor 310 detects (e.g., before, after, and/or as a result of the request for sensor information) sensor data and sends the sensor data to one or more secure services, drivers, or applications (e.g., secure drivers 312A-312G). As illustrated in FIG. 3A, first sensor 308 sends sensor data to secure drivers 312A-312D and second sensor 310 sends sensor data to secure drivers 312A and 312E-312G. To note, secure drivers 312A receives sensor data from both first sensor 308 and second sensor 310 while secure drivers 312B receives sensor data from first sensor 308 but not second sensor 310. It should be recognized that one or more secure drivers can receive sensor data from more or fewer sensors, including from only a single sensor, from a different sensor than illustrated in FIG. 3A, or from three or more sensors. It should also be recognized that a secure driver can correspond to any component of second operating system 312, such as an application of applications 320, a driver of drivers 218, a service of services 216 and/or a component of microkernel 214.

In some examples, sensor data received by a secure driver is detected at different times and/or the same time. For example, first sensor 308 can detect first sensor data and send the first sensor data to secure driver 312A while second sensor 310 can detect second sensor data after the first sensor data is detected and send the second sensor data to secure driver 312A.

In some examples, a secure drivers (e.g., secure drivers 312A-312G) receives sensor data and performs one or more operations, determinations, and/or calculations using the sensor data. For example, the secure driver can determine whether sensor data exceeds a threshold (e.g., a predefined threshold stored and/or configured for the secure driver, such as an amount of light, an amount of sound, a particular person in an image, a number of people in an image, a number of heart beats, and/or whether an irregular heart beat is present) and output a positive or negative indication (sometimes referred to as metadata herein) based on whether the sensor data exceeded the threshold. In such an example, the positive or negative indication can be sent to another secure drivers (e.g., secure drivers 312B-312D and/or secure drivers 312E-312G) and/or filter layer 314.

In some examples, the one or more operations, determinations, and/or calculations are provided to and/or set for the secure drivers (e.g., by a developer and/or process (e.g., executing in microkernel domain 302) associated with the secure driver) before or after the secure driver initiates execution. For example, the secure driver can include an interface description language (IDL) that defines how a component (e.g., daemon 318 and/or application 320) is able to interact with the secure driver via filter layer 314. In some examples, the IDL for the secure driver defines a message and/or request that is used to interact with the secure driver. For example, the IDL can define that a component can request whether the sensor data exceeds the threshold, limiting interactions with the secure driver to whether the sensor data exceeds the threshold, and not allowing other types of interactions. In some examples, an IDL for a secure driver can include an inter-process communication (IPC) address for the secure driver, such that communications to the secure driver use the IPC communication.

As mentioned above, the secure driver can output data (e.g., sometimes referred to as metadata corresponding to sensor data) and send to another secure driver and/or filter layer 314. In some examples, the other secure driver receives metadata from the secure driver and also sensor data from a sensor (e.g., first sensor 308 and/or second sensor 310) and performs one or more operations, determinations, and/or calculations based on the metadata and the sensor data to output its own metadata to be sent to another secure driver and/or filter layer 314.

At FIG. 3A, filter layer 314 receives metadata from one or more secure drivers and sensor data from one or more sensors (e.g., collectively referred to as sensor information) and determines what to output outside of filter layer 314. In some examples, filter layer 314 executes within microkernel domain 302 (e.g., as a service of services 216, an application of applications 220, or as part of microkernel 214), within kernel domain 304 (e.g., as a daemon of daemons 208, as part of kernel 204, or as a system process of kernel 204), or outside of microkernel domain 302 and kernel domain 304. In some examples, filter layer 314 acts as a gateway for sensor information from microkernel domain 302 to kernel domain 304. In some examples, filter layer 314 restricts access to sensor information from a component in kernel domain 304 and/or user domain 306. For example, filter layer 314 can allow a camera to operate as a light sensor and/or motion sensor without providing images to daemon 318 by receiving metadata from a secure driver indicating whether light or motion is present and, then, providing the metadata to daemon 318 instead of an image (e.g., the images and/or any image).

In some examples, filter layer 314 determines a current context of device 10 and, based on the current context, determines what to output to daemon 318. For example, filter layer 314 can determine whether indicator 316 is on (e.g., active) and, in response to determining that indicator 316 is on, output sensor data (e.g., as illustrated in FIG. 3A) instead of metadata corresponding to the sensor data (e.g., as illustrated in FIG. 3B and discussed further below) as a response to the request for sensor information from daemon 318 discussed above. In some examples, similar or the same as described above with respect to filter layer 314, daemon 318 determines a current context of device 10 and, based on the current context, determines what to output to application 320. In other examples, daemon 318 outputs what it received from filter layer 314 to application 320 without any determination of the current context.

As described above, filter layer 314 and/or daemon 318 can determine a current context of device 10. In some examples, as part of determining the current context of device 10, filter layer 314 and/or daemon 318 sends a request to change a state of device 10 to cause the current context of device 10 to satisfy a set of criteria needed for processing a request. For example, when indicator 316 must be on (e.g., the set of criteria includes a criterion that is satisfied when indicator 316 is on), filter layer 314 and/or daemon 318 can send a request to cause indicator 316 to be on before continuing with a current request. Accordingly, if the request to cause indicator 316 is successful, the current request can be processed without needing to change what type of data is provided as a response.

In some examples, the sensor data provided to daemon 318 and to application 320 is a different resolution than detected by a sensor (e.g., first sensor 308 and/or second sensor 310). In such examples, filter layer 314 determines, based on the current context of device 10, what resolution of sensor data to send to daemon 318 and/or application 320. In some examples, based on the determined resolution, filter layer 314 sends sensor data with that resolution to daemon 318. For example, the sensor can provide images at a rate of 1 per millisecond while filter layer 314 and/or daemon 318 can provide images at a rate of 1 per second (e.g., a lower resolution than 1 per millisecond).

Turning now to FIG. 3B, a block diagram illustrates flow of sensor data from one or more sensors (e.g., first sensor 308 and/or second sensor 310) to one or more secure drivers secure drivers 312A-312G and metadata from the one or more secure drivers to a filter layer 314, a daemon 318, and then to an application 320.

As described above with respect to FIG. 3A, FIG. 3B illustrates first sensor 308 and second sensor 310 sending sensor data to secure drivers 312A-312G and filter layer 314, and secure drivers 312A-312G sending metadata to filter layer 314. However, rather than filter layer 314 sending sensor data to daemon 318 as illustrated in FIG. 3A, filter layer 314 sends metadata to daemon 318.

In some examples, the metadata is sent to daemon 318 in response to a request for the metadata from daemon 318 (e.g., daemon 318 either received a request for the metadata from application 320 or daemon 318 determined that a current context of device 10 requires metadata to be provided instead of sensor data). In other examples, the metadata is sent to daemon 318 in response to a request for sensor information (e.g., sensor data and/or metadata) from daemon 318 (e.g., daemon either received a request for sensor information, sensor data, or metadata from application 320 or daemon 318 determined that a current context of device 10 requires filter layer 314 to determine what to send to daemon 318 as a response). As illustrated in FIG. 3B, indicator 316 is off (e.g., inactive) as opposed to on (e.g., as illustrated in FIG. 3A). In some examples, indicator 316 being off causes metadata to be sent to daemon 318 rather than sensor data.

While described as metadata above, it should be recognized that metadata can have different resolutions (e.g., can include different amounts of data and/or specificity). In some examples, filter layer 314 determines, based on the current context of device 10, what resolution of metadata to send to daemon 318 and/or application 320 and, based on the determined resolution, sends metadata with that resolution to daemon 318. For example, filter layer 314 can receive a first indication that a particular person is detected in an image and a second indication that there is a person present in an environment (e.g., the particular person is identified in the first indication and not the second indication). In such an example, filter layer 314 can provide either the first indication (e.g., a higher resolution than the second indication because the particular person is identified) or the second indication (e.g., a lower resolution than the first indication because the particular person is not identified) to daemon 318 depending on the current context of device 10 and/or what application is requesting such information.

Turning now to FIG. 3C, a block diagram illustrates flow of sensor data from one or more sensors (e.g., first sensor 308 and/or second sensor 310) to one or more secure drivers 312A-312G and a filter layer 314, metadata from the one or more secure drivers to the filter layer, and neither the metadata or the sensor data to a daemon 318 and an application 320.

As described above with respect to FIGS. 3A-3B, FIG. 3C illustrates first sensor 308 and second sensor 310 sending sensor data to secure drivers 312A-312G and filter layer 314, and secure drivers 312A-312G sending metadata to filter layer 314. However, rather than filter layer 314 sending sensor data (e.g., as illustrated in FIG. 3A) or metadata (e.g., as illustrated in FIG. 3B) to daemon 318, filter layer 314 sends data to daemon 318 indicative that sensor data and metadata cannot be sent based on a current context of device 10.

In some examples, the data is sent to daemon 318 in response to a request for sensor information (e.g., sensor data and/or metadata) from daemon 318 (e.g., daemon either received a request for sensor information, sensor data, or sensor metadata from application 320 or daemon 318 determined that a current context of device 10 requires filter layer 314 to determine what to send to daemon 318 as a response). As illustrated in FIG. 3C, indicator 316 is off (e.g., inactive). In some examples, indicator 316 being off causes the data to be sent to daemon 318 rather than sensor data or metadata. It should be recognized that other context can cause filter layer 314 to send sensor data of different resolutions, metadata of different resolutions, or neither to daemon 318.

It should be recognized that, while FIGS. 3A-3C illustrate a single application (e.g., application 320) interacting with filter layer 314 via daemon 318, different applications (e.g., of the same type or different type) can communicate with filter layer 314 via daemon 318 (or another daemon) via the same operations with the same or different criteria as described above with respect to application 320. For example, filter layer 314 and/or daemon 318 can have different criteria for different applications and/or different types of applications when determining how to respond to a request.

Various examples of hardware accelerators 130 that use exclaves 132 to extend the secure environment afforded by the software architecture described with respect to FIGS. 2 and 3 will now be discussed.

Turning now to FIG. 4, a block diagram of display unit 140 is depicted. As noted above, display unit 140 includes circuitry configured to render frames for presentation on a display of device 10 such as discussed below with FIG. 12. In the illustrated embodiment, display unit 140 includes display pipeline 410, which includes secure blend 412 and secure extractor 416. Display unit further includes a secure direct memory access (DMA) engine 420. In other embodiments, display unit 140 may be implemented differently than shown—e.g., DMA engine 420 may be considered as part of pipeline 410.

Display pipeline 410 is circuitry configured to process input data 402 to produce output frames 404. Accordingly, pipeline 410 may be configured to perform various operations such as panel compensation, swizzling, dithering, cropping, timing control, DisplayPort™ transmission, etc. In the illustrated embodiment, display unit 140 is configured to implement an exclave 132A to extend the enforcement of one or more security criteria of the secure environment with respect to pipeline 410 by using a secure blend 412, secure extractor 416, and secure DMA 420. In doing so, elements 412-420 serve to physically isolate distributed trusted data 122A by providing a separate data path controlled from the secure environment by one or more processes 112A in order to enable pipeline 410 to perform tasks associated with untrusted processes 112B and trusted processes 112A. As shown, exclave 132A provides a way for a trusted process 112 to have pixel data 414 combined with input pixel data 402 provided by an untrusted process 112B.

Secure blend 412 is an additional pipeline stage that includes circuitry configured to insert pixel data 414 from a trusted process 112A into an output frame 404 prior to presenting output frame 404 via the display. For example, inserted pixel data 414 may appear as one or more colored dots in an upper right corner of frame 404. As shown, inserted pixel data 414 can be used to convey an indicator 316 of a component of device 10 being active such as a sensor configured to collect sensitive data (e.g., health, location, etc.) about a user, a camera, a microphone, hardware interfaces, etc. Inserted pixel data 414 can also be used to convey indicators 316 associated with particular software such as notifying a user that screensharing is occurring, credential information is being accessed, payment information is being sent to a merchant- or even convey notifications not associated with sensitive information. In some embodiments, pixel data 414 received by secure blend 412 is created by a trusted process 112A responsible for notifying a user. In other embodiments, secure blend 412 may generate pixel data 414 itself in response to a request (or some other indication) from the secure environment. Secure blend 412 may also perform other tasks such as adding a ring around inserted pixel data 414 in order to prevent it from being obscured when inserted to a frame 404 having the same color background.

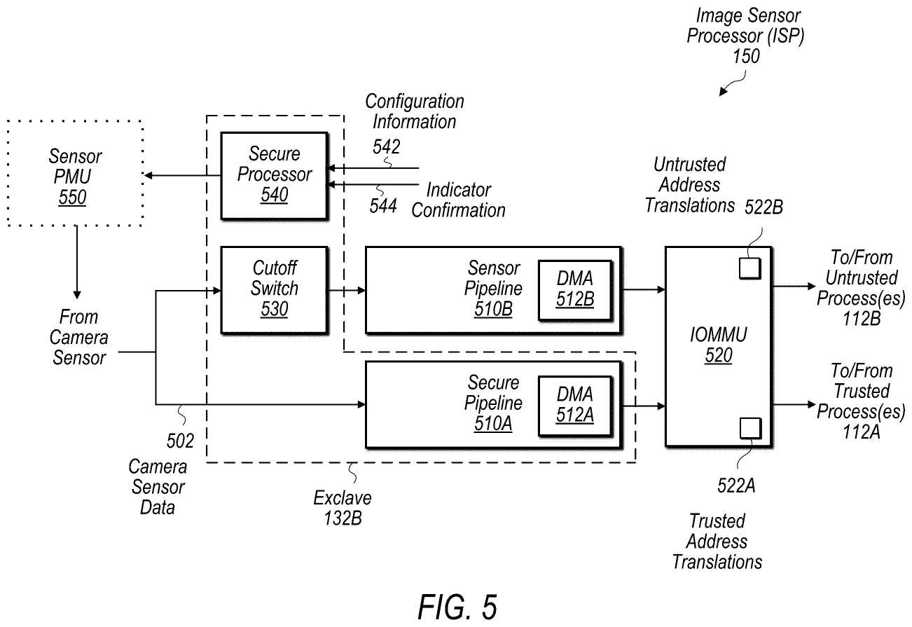

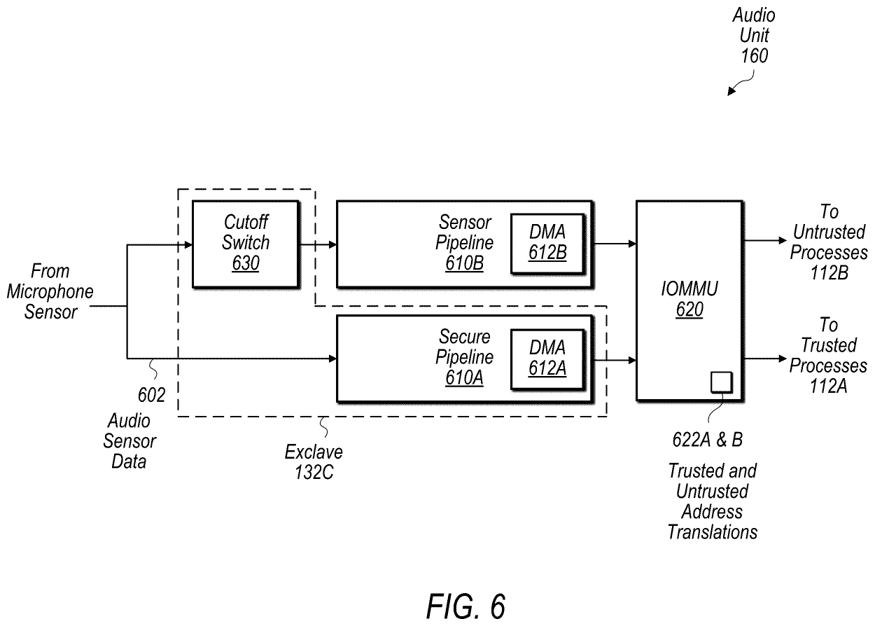

Secure extractor 416 is an additional pipeline stage that includes circuitry configured to extract pixel data 414 from where pixel data 414 was previously inserted into an output frame 404 in order to conform that it still remains present in the frame 404 headed to the display. Secure extractor 416 may also check other details such as performing a CRC check, verifying whether the display is active and communicating with pipeline 410, etc. In the illustrated embodiment, secure extractor 416 provides the extracted pixel data to a trusted process 112A for analysis (such as a process 112A associated with filter layer 314)—although, in other embodiments, extractor 416 may analyze data 414 locally and covey a result. If the analysis determines that pixel data 414 corresponding to indicator 316 remains inserted into output frames 404, usage associated with indicator 316 may be permitted to continue. Otherwise, corrective actions may be taken as will be discussed with FIGS. 5 and 6. In various embodiments, secure extractor 416 is configured to periodically provide extracted pixel data 414, so that the presence of inserted pixel data 414 can be continually confirmed.

Secure DMA engine 420 is circuitry configured to communicate pixel data 414 between exclave 132A and the regions of memory 120 assigned to trusted processes 112A. In the illustrated embodiment, secure DMA engine 420 is a second, separately controlled DMA engine from the primary DMA engine configured to retrieve input data 402 from memory 120 for display pipeline 410. Secure DMA engine 420 may also be inaccessible to components outside of the secure environment and may handle only requests originating from within the secure environment or an exclave 132. In providing this separate data path, secure DMA engine 420 can ensure components of exclave 132A do not process data 112B received from untrusted processes 112B in order to make it more difficult for a malicious process 112B to interfere with tasks being performed by exclave 132A.

Various features described above with respect to display unit 140 may also be used by other user interface circuitry such as an audio pipeline circuitry in audio unit 160 to insert an auditable indicator into an audio signal, a haptic feedback engine to insert a particular haptic indicator into haptic feedback data, etc. In some embodiments, display unit 140 may also implement techniques used by other accelerators 130 such as IOMMUs. Hardware accelerators 130 that can control access to sensor data based on an extracted pixel data 414 will now be described next with FIGS. 5 and 6.

Turning now to FIG. 5, a block diagram of image signal processor (ISP) 150 is depicted. As noted above, ISP 150 includes sensor processor circuitry configured to process sensor data received from a camera. In the illustrated embodiment, ISP 150 includes sensor pipelines 510, an input-output memory management unit (IOMMU) 520, cutoff switch 530, secure processor 540. In other embodiments, ISP 150 may be implemented differently than shown, techniques described with respect to ISP 150 may be implemented by other hardware accelerators 130, ISP 150 may implement different techniques such as those described with other hardware accelerators 130, etc.

Sensor pipelines 510 include circuitry configured to perform various image processing operations such as sensor compensation, color space encoding, scaling, rotation, format encoding, etc. In the illustrated embodiment, ISP 150 implements an exclave 132B to extend the enforcement of one or more security criteria of the secure environment by using secure pipeline 510A, IOMMU 520, cutoff switch 530, and secure processor 540. In doing so, ISP 150 can securely provide processed camera sensor data 502 to trusted processes 112A (or other trusted consumers) and negotiate one or more conditions in which untrusted processes 112B (or other untrusted consumers) are permitted to receive processed sensor data 502—such as confirmation that indicator 316 is currently being provided to a user via pixel data 414.

Secure pipeline 510A is an additional pipeline that provides data isolation for camera sensor data 502 for trusted processes 112 while unsecure pipeline 510B processes data 502 for unsecured processes 112. In some instances, it may be desirable to perform certain tasks without burdening the user with additional indicators 316. For example, a trusted process 112A may continually analyze camera sensor 502 processed by pipeline 510A to determine whether a user is paying attention to device 10 in order to potentially implement various power saving techniques such as dimming the display when the user is not paying attention, etc. A trusted process 112A or trusted hardware may also be used to perform a biometric authentication of a user using facial recognition, iris recognition, etc. Usage of a separate secure pipeline 510A from pipeline 510B can make it harder for a malicious process 112B to circumvent the security criteria being enforced by exclave 132B. It also can prevent a malicious process 112B from starving access to camera sensor data 502 used by trusted processes 112A. In some embodiments, usage of pipeline 510A may also allow for ISP 150 to provide greater capabilities to trusted processes 112A, which may be less desirable for untrusted processes 112B, such as higher resolutions, frame rates, etc. In order to avoid comingling tasks of trusted and untrusted processes 112, pipelines 510 may be separately addressable by processes 112 such that only processes 112A within the secure environment (or other trusted entities) can address resources associated with secure pipeline 510A. ISP 150 may also receive other indications to distinguish between trusted and untrusted entities such as information received from fabric 102 about the sources of requests and address translations 522 discussed below. In illustrated embodiment, pipelines 610 also use separate DMA engines 612 to issue memory requests to memory 120. As shown, direct DMA engine 512A is configured to write sensor data 502 processed by pipeline 510A to a portion of memory 120 accessible to trusted processes 112A (or regions accessible to other trusted consumer); DMA engine 512B is configured to write sensor data 502 processed by pipeline 510B to another portion of memory accessible to untrusted processes 112B (or regions accessible to other untrusted consumer).

IOMMU 520 is circuitry configured to communicate memory requests from DMAs 512 to memory 120 via fabric 102. As part of this communication, IOMMU 520 translates virtual addresses specified in the memory requests to their corresponding physical addresses known to memory 120. In the illustrated embodiment, IOMMU 520 restricts tasks associated with untrusted processes 112B from accessing memory regions assigned to trusted processes 112A by storing separate sets of address translations 522A and 522B for trusted processes 112A and untrusted processes 122B, respectively. Accordingly, when a memory request is received DMA 512B for an untrusted process 112B, IOMMU 520 accesses its untrusted address translations 522B and, if a corresponding translation 522B is stored, translates the virtual address specified in the request to its corresponding physical address for communication to memory 120. If, however, no corresponding translation 522B is stored, IOMMU 520 is unable to perform the translation preventing tasks associated with untrusted processes 112 from accessing unauthorized memory regions such as those assigned to trusted processes 112A. Tasks associated with trusted processes 112A being handled by secure pipeline 510A may also be barred from accessing regions assigned to untrusted processes 112B if no corresponding translation is stored in the set of trusted address translations 522A. IOMMU 520 may determine which set of translations 522A or 522B to access for a given memory request based on the particular DMA 512A or 512B issuing that memory request. In some embodiments, translations 522 are provided by SPTM 210 discussed above.

Cutoff switch 530 is circuitry configured to control whether sensor data 502 is permitted to flow to sensor pipeline 510B and thus unto an untrusted process 112B. In response to the one or more conditions for providing data 502 being satisfied (such indicator 316 being provided via display unit 140), switch 530 allows the flow of data 502 to pipeline 510A. If, however, one or more of the conditions have been violated, switch 530 is configured to interrupt the data path through which data 502 is being provided to pipeline 510. In some embodiments, cutoff switch 530 is configured as a dead man's switch that remains enabled while confirmations that the criteria are satisfied are periodically received but that, in response to an omission of the confirmation, interrupts providing the data 502 to pipeline 510A. In some embodiments, cutoff switch 530 is controlled by secure processor 540 based on an indicator confirmation 544.

Secure processor 540 is a processor configured to manage various operations of ISP 150. To enable processor 540 to be controlled from the secure environment by one or more trusted processes 112A, secure processor 540 may include one or more configuration registers configured to store configuration information 542 controlling operation of the camera sensor and addressable only by processes 112A within the secure environment. This configuration information 542 may be used to control particular settings of camera, control the behaviors of pipeline 510, etc. In the illustrated embodiment, when camera sensor data 502 is being accessed by an untrusted process 112B, secure processor 540 receives indicator confirmation 544 confirming whether indicator 316 is being presented to the user (or more generally that the one or more criteria for providing data 502 has been satisfied). As noted above, this confirmation 544 may be provided by a trusted process 112A analyzing extracted pixel 414 from display unit 140. Secure processor 540 may also be responsible for providing an indication that the camera sensor is active to a corresponding process 112A executable to produce indicator 316. In some embodiments, secure processor 540 periodically receives an indicator confirmation 544 while the sensor is active as a heartbeat signal indicating that the one or more conditions for providing access to camera sensor data 502 have been satisfied. In response to determining that the heartbeat signal is no longer being received, sensor processor 540 can take one or more corrective actions to discontinue providing sensor data 502 to an untrusted process 112B. In the illustrated embodiment, secure processor 540 is coupled to sensor power management unit 550, which is configured to provide power to the camera sensor. In response to determining that the one or more conditions for providing access to sensor data 502 have been violated, secure processor 540 can instruct PMU 550 to power gate the sensor. Processor 540 may also instruct switch 530 to interrupt the data path providing data 502.

Although the description with respect to ISP 150 is presented within the context of a camera, this description is also applicable to other sensor types such as those noted above and a microphone as discussed next.

Turning now to FIG. 6, a block diagram of audio unit 160 is depicted. As noted above, audio unit 160 includes sensor processor circuitry configured to process audio signals received from one or more microphone sensors of device 10. In some embodiments, audio unit 160 also includes circuitry (not shown) for driving one or more speakers. In the illustrated embodiment, audio unit 160 includes sensor pipelines 610, IOMMU 620, and cutoff switch 630. In other embodiments, audio unit 160 may be implemented differently than shown, techniques described with respect to audio unit 160 may be implemented by other hardware accelerators 130, audio unit 160 may implement different techniques such as those discussed other hardware accelerators 130, etc.

Sensor pipelines 610A and 610B includes circuitry configured to perform audio signal processing such as amplifiers, analog to digital convertors (ADCs), filters, digital signal processors (DSPs), audio encoders, DMA engines 612, etc. In the illustrated embodiments, audio unit 160 implements an exclave 132C to extend the enforcement of one or more security criteria of the secure environment by using secure pipeline 610A, IOMMU 620, and cutoff switch 630. Similar to pipeline 510A, secure pipeline 610A is an additional pipeline that provides data isolation for audio sensor data 602 for trusted processes 112 and can be used independently of unsecure pipeline 510B processing data 602 for untrusted processes 112B. To maintain this separation, pipeline 610A also includes a separate DMA 612A to ensure data separation for memory requests issued from secure pipeline 610A from memory requests issued by DMA 612B from secure pipeline 610B. IOMMU 620 is similarly configured to service these memory requests by storing a first set of memory address translations 622A (and thus memory addresses) designated as being accessible to secure pipeline 610A and a second set of memory address translations 622B designated as being accessible unsecure pipeline 610B and restricting secure pipeline 610A from accessing memory address translations 622A (and thus memory addresses associated with those translations 622A) outside of the first set and unsecure pipeline 610B from accessing memory address translations 622B outside of the second set. Cutoff switch 630 is similarly configured to enable or disable providing audio sensor data 602 to an untrusted process 112B via sensor pipeline 610B in response to the one or more security criteria being satisfied.

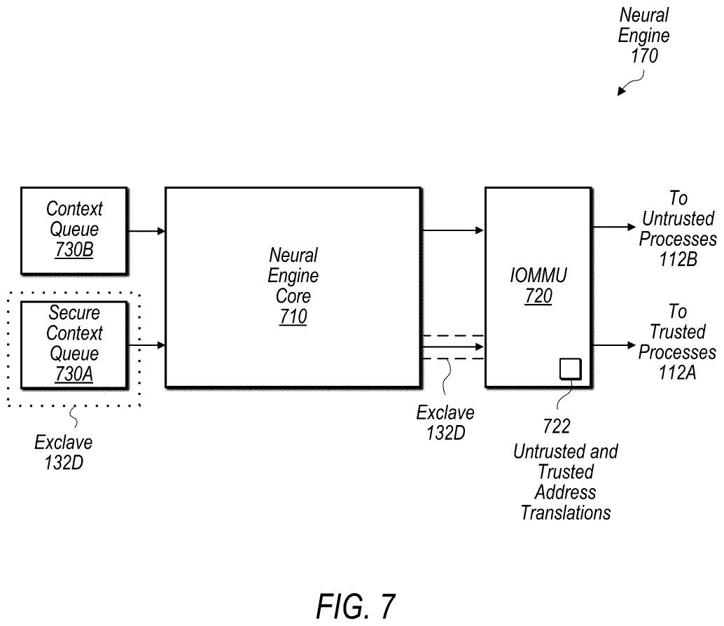

Turning now to FIG. 7, a block diagram of neural engine 170 is depicted. As noted above, neural engine 170 includes circuitry configured to perform machine learning operations such as those associated with neural networks. As shown, neural engine 170 includes a neural engine core 710, IOMMU 720, and multiple context queues 730. In other embodiments, neural engine 170 may be implemented differently than shown, techniques described with respect to neural engine 170 may be implemented by other hardware accelerators 130, neural engine 170 may implement different techniques such as those described with other hardware accelerators 130, etc.

Neural engine core 710 includes circuitry configured to perform various neural network operations such as those associated with matrix multiplication, activation function application, backpropagation calculation, or various other tensor operations. As shown, neural engine core 710 can be used to perform sensitive tasks assigned by trusted processes 112A, which can include user authentication, speech detection for activation of a voice assistant, attention awareness, etc. In order to ensure separation of tasks assigned by untrusted processes 112A and tasks assigned by untrusted processes 112B, neural engine 170 implements an exclave 132D using IOMMU 720 and one or more secure queues 730A.

In various embodiments, separate context queues 730 are used to preserve state for separate contexts associated with processes 112A and 112B. When transitioning between performance of tasks, neural engine core 710 may implement a context switch in which state from performance of one task is offloaded to a queue 730 and state for performance another task is loaded into core 710 from a queue 730. In the illustrated embodiment, a separate secure context queue 730A is used to physically isolate state data 122A belonging to trusted processes 112A. As this separate secure context queue 730A serves as an additional data buffer to store distributed data 122A associated with trusted processes 112A and does not store distributed data 122B associated with untrusted processes 112B, distributed data 122A can be protected from untrusted processes 112B. Furthermore, IOMMU 720 can restrict access to queues 730 by processes 112A and 112B using untrusted and trusted address translations 722 as discussed above with IOMMUs 520 and 620 as well as restrict the memory requests issued by the contexts associated with queues 730.

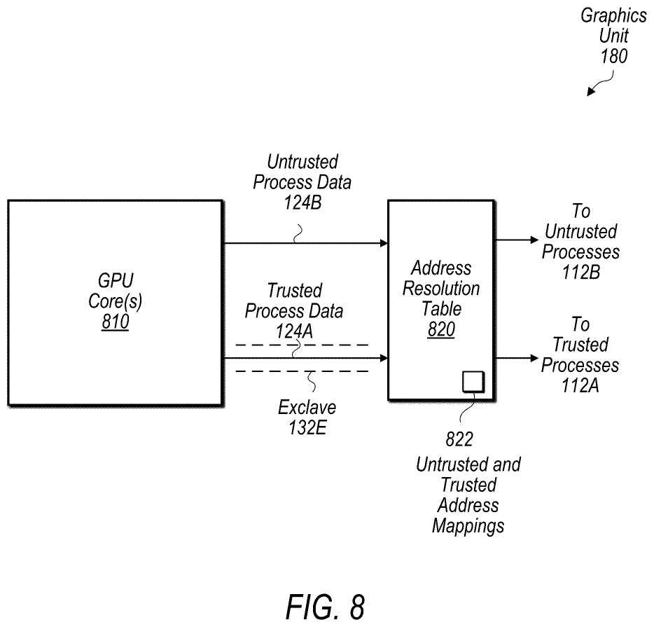

Turning now to FIG. 8, a block diagram of graphics unit 180 is depicted. As noted above, graphics unit 180 includes circuitry configured to render graphical content or perform other forms highly parallelized tasks as will be discussed with FIG. 12. As shown, graphics unit 180 may include one or more graphics processor unit (GPU) cores 810 and an address resolution table 820. In other embodiments, graphics unit 180 may be implemented differently than shown, techniques described with respect to graphics unit 180 may be implemented by other hardware accelerators 130, graphics unit 180 may implement different techniques such as those described with other hardware accelerators 130, etc.

As with other accelerators 130, GPU cores 810 may be configured to perform tasks assigned by trusted processes 112A and tasks assigned by untrusted processes 112B. In order to ensure data separation of trusted process data 122A and untrusted process data 122B during performance of these tasks, in the illustrated embodiment, graphics unit 180 implements an exclave 132E using an address resolution table 820. In some embodiments, GPU cores 810 (or other components of graphics unit 180 such as internal CPU managing cores 810) issue memory requests specifying the physical addresses of memory 120 (as opposed to virtual addresses corresponding to those physical addresses). As no virtual address translation is being performed, graphics unit 180 may not use an IOMMU as discussed above with other accelerators 130. Instead, an address resolution table 820 maintains trusted and untrusted address mappings 820 identifying the memory regions of memory 120 assigned to the trusted processes 112A and memory regions of memory 120 assigned to the untrusted processes 112B. In some embodiments, these mappings 822 are provided by SPTM 210 discussed above and may specify the physical addresses accessible to a task associated with a given process 112A or 112B. Accordingly, when GPU cores 810 perform tasks assigned to an untrusted process 112B, GPU cores 810 may issue memory requests specifying physical addresses to table 820. If a corresponding mapping 822 exists in the table 820 for that process 112B, the memory requests may be allowed to travel across fabric 102 to memory 120. Otherwise, those memory requests may be barred by table 820. In some embodiments, exclave 132E also uses separate DMA engines for issuing memory requests with respect to data 122A and 122B as discussed above.

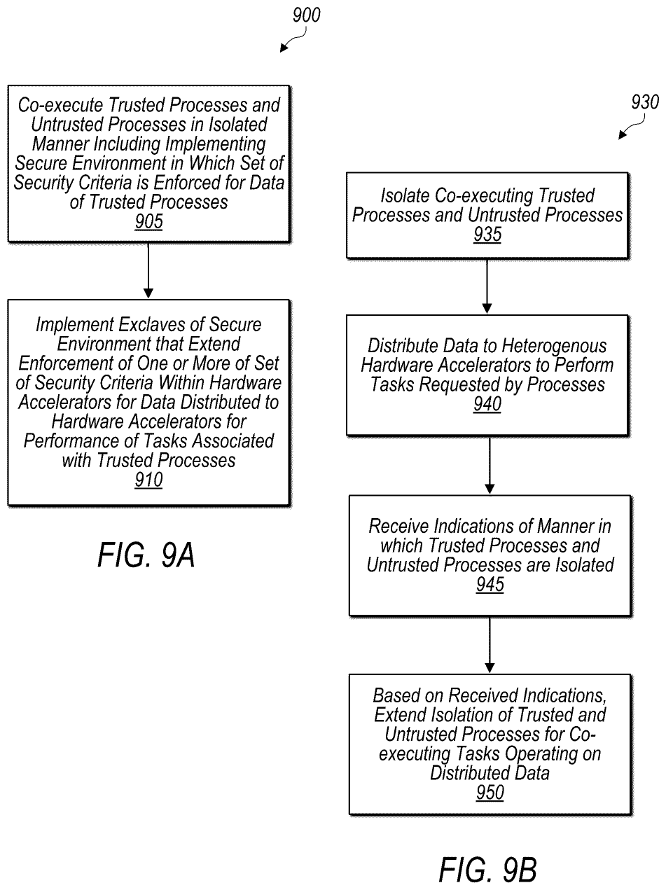

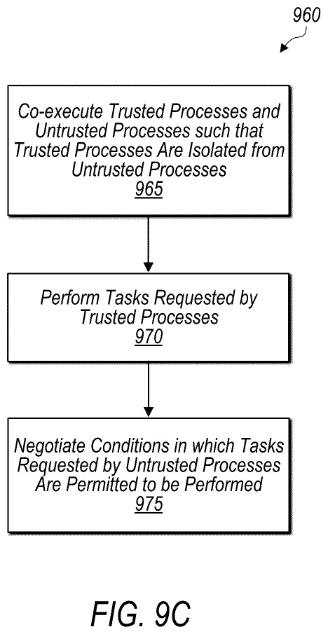

Turning now to FIG. 9A, a flow diagram of a method 900 is depicted. Method 900 is one embodiment of a method performed by a computing device such as device 10. In many instances, performance of method 900 can greatly improve the security of the computing device. In some embodiments, method 900 may be implemented differently than shown.

In step 910, one or more processors (e.g., processors 110) of the computing device co-execute trusted processes (e.g., trusted processes 112A) and untrusted processes (e.g., untrusted processes 112B) in an isolated manner that includes implementing a secure environment in which a set of security criteria is enforced for data of the trusted processes (e.g., trusted process data 122A).

In step 920, multiple heterogenous hardware accelerators (e.g., hardware accelerators 130) implement exclaves (e.g., exclaves 132) of the secure environment that extend enforcement of one or more of the set of security criteria within the hardware accelerators for data distributed to the hardware accelerators for performance of tasks associated with the trusted processes. In various embodiments, to extend the enforcement of the one or more security criteria, one or more of the hardware accelerators restrict tasks associated with the untrusted processes from accessing memory regions (e.g., of memory 120) assigned to the trusted processes. In some embodiments, to restrict the tasks, the one or more hardware accelerators store virtual-to-physical address translations (e.g., translations 522, 622, and 722) for the memory regions assigned to the trusted processes and for memory regions assigned to the untrusted processes and prevent the tasks associated with the untrusted processes from accessing the virtual-to-physical address translations for the memory regions assigned to the trusted processes. In some embodiments, the one or more hardware accelerators include a graphics processing unit (GPU) (e.g., graphics unit 180) that maintains a table (e.g., address resolution table 820) identifying the memory regions assigned to the trusted processes and memory regions assigned to the untrusted processes and performs memory accesses in accordance with the table.

In various embodiments, to extend the enforcement of the one or more security criteria, one or more of the hardware accelerators physically isolate the distributed data associated with the trusted processes from distributed data associated with the untrusted processes. In some embodiments, the one or more hardware accelerators include pipelines (e.g., pipelines 410, 510 and 610) that perform tasks associated with the untrusted processes and tasks associated with the trusted processes. In some embodiments, the pipelines include one or more additional pipeline stages that process the distributed data associated with the trusted processes and do not process the distributed data associated with the untrusted processes. In some embodiments, the one or more hardware accelerators include a display unit having a display pipeline that renders frames for a display of the computing device. In some embodiments, the display pipeline includes a blend pipeline stage (e.g., secure blend 412) that blends pixel data (e.g., inserted pixel data 414) received from a trusted process into a frame (e.g., output frame 404) being rendered by the display pipeline and including pixel data from an untrusted process. In some embodiments, the display pipeline includes an extraction pipeline stage (e.g., secure extractor 416) that extracts pixel data (e.g., extracted pixel data 414) from a frame being rendered by the display pipeline and provides the extracted pixel data to a trusted process. In some embodiments, the one or more hardware accelerators include one or more additional data buffers that store the distributed data associated with the trusted processes and do not store the distributed data associated with the untrusted processes. In some embodiments, the one or more hardware accelerators include a neural engine (e.g., neural engine 170) that performs set of neural network operations and includes the one or more data buffers (e.g., secure context queue 730A) to store distributed data for tasks associated with the trusted processes.

In various embodiments, to extend the enforcement of the one or more security criteria, one or more of the hardware accelerators restrict sensor data provided to trusted processes from being provided to untrusted processes. In some embodiments, the one or more hardware accelerators include an image signal processor (e.g., ISP 150) that processes sensor data (e.g., camera sensor data 502) received from a camera sensor and includes a cutoff switch (e.g., cutoff switch 530) to enable or disable providing the sensor data to an untrusted process in response to the one or more security criteria being satisfied. In some embodiments, the one or more criteria include an indication being present in a frame being displayed to a user to indicate that the camera sensor is currently in use. In some embodiments, the one or more hardware accelerators include an audio unit (e.g., audio unit 160) that processes sensor data (e.g., sensor data 602) received from a microphone sensor and includes a cutoff switch (e.g., cutoff switch 630) to enable or disable providing the sensor data to an untrusted process in response to the one or more security criteria being satisfied.

Turning now to FIG. 9B, a flow diagram of a method 930 is depicted. Method 930 is one embodiment of a method performed by a computing device such as device 10. In many instances, performance of method 930 can greatly improve the security of the computing device. In some embodiments, method 930 may be implemented differently than shown.

Method 930 begins in step 935 with the computing device isolating co-executing trusted processes (e.g., trusted processors 112A) and untrusted processes (e.g., untrusted processes 112B). In step 940, the computing device distributes data to ones of the plurality of heterogenous hardware accelerators to perform tasks requested by the processes. In step 945, heterogenous hardware accelerators of the computing device receive indications of a manner in which the trusted processes and untrusted processes are isolated. In step 950, the heterogenous hardware accelerators extend, based on the received indications, isolation of the trusted and untrusted processes for co-executing tasks operating on the distributed data.

Turning now to FIG. 9C, a flow diagram of a method 960 is depicted. Method 960 is one embodiment of a method performed by a computing device such as device 10. In many instances, performance of method 960 can greatly improve the security of the computing device. In some embodiments, method 960 may be implemented differently than shown.

Method 960 begins in step 965 with one or more processors (e.g., processors 110) of the computing device co-executing trusted processes (e.g., trusted processes 112A) and untrusted processes (e.g., untrusted processes 112B) such that the trusted processes are isolated from the untrusted processes. In step 970, multiple heterogenous hardware accelerators (e.g., accelerators 130) of the computing device 10 perform tasks requested by the trusted processes. In step 975, the hardware accelerators negotiate conditions in which tasks requested by the untrusted processes are permitted to be performed.

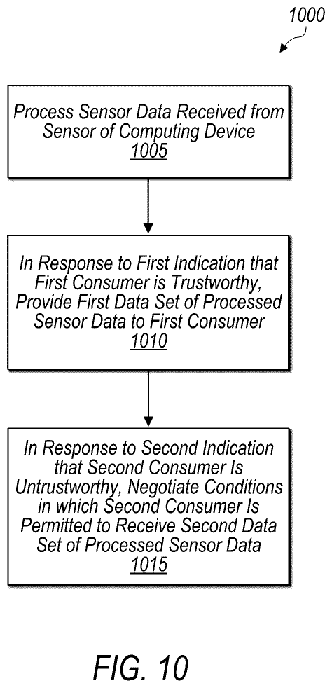

Turning now to FIG. 10, a flow diagram of a method 1000 is depicted. Method 1000 is one embodiment of a method performed by a computing device including a sensor and sensor processor circuitry such as device 10. In many instances, performance of method 1000 can greatly improve the security of the computing device. In some embodiments, method 1000 may be implemented differently than shown.

In step 1005, sensor processor circuitry processes sensor data received from a sensor of the computing device. In some embodiments, the sensor processor circuitry is an image signal processor (e.g., ISP 150) configured to process sensor data received from a camera. In some embodiments, the sensor processor circuitry is an audio processor (e.g., audio unit 160) configured to process sensor data received from a microphone.

In step 1010, in response to a first indication that a first consumer is trustworthy, sensor processor circuitry provides a first data set of the processed sensor data to the first consumer. In various embodiments, the first indication identifies the first consumer as residing in a secure environment in which a set of security criteria is enforced for the first data set; the second indication identifies the second consumer as residing outside of the secure environment. In some embodiments, the computing device implements a secure execution environment of the secure environment in which the first consumer is a first process (e.g., a trusted process 112A) executing within the secure execution environment and the second consumer is a second process (e.g., untrusted process 112B) executing external to the secure execution environment. In some embodiments, the sensor processor circuitry includes one or more configuration registers (e.g., in secure processor 540) that store configuration information (e.g., configuration information 542) controlling operation of the sensor and are addressable only by entities within the secure environment.

In step 1015, in response to a second indication that a second consumer is untrustworthy, sensor processor circuitry negotiates one or more conditions in which the second consumer is permitted to receive a second data set of the processed sensor data. In some embodiments, sensor processor circuitry provides an indication that the sensor is active. In some embodiments, the one or more conditions include the sensor processor circuitry receiving confirmation that a user is being notified that the sensor is active. In some embodiments, a display pipeline circuitry (e.g., display pipeline 410) of the computing device inserts, in response to the provided indication, pixel data (e.g., pixel data 414) in a frame (e.g., output frame 404) being presented on a display to notify the user is being notified that the sensor is active. In some embodiments, in response to determining to provide the second data set to the second consumer, the sensor processor circuitry periodically receives a heartbeat signal (e.g., indicator confirmation 544) indicating that the one or more conditions have been satisfied and discontinues providing the second data set in response to determining that the heartbeat signal is no longer being received. In some embodiments, in response to the one or more conditions being violated, a switch (e.g., cutoff switch 530 and 630) of the sensor processor circuitry interrupts a data path through which the second data set is being provided to the second consumer. In some embodiments, the sensor processor circuitry power gates (e.g., sensor PMU 550) the sensor in response to determining that the one or more conditions have been violated. In some embodiments, a secure pipeline (e.g., secure pipelines 510A and 610A) of the sensor processor circuitry processes sensor data to produce the first data set for the first consumer; an unsecure pipeline of the sensor processor circuitry processes sensor data to produce the second data set for the second consumer. In some embodiments, an input-output memory management unit (IOMMU) (e.g., IOMMUs 520, 620, and 720) of the computing device stores a first set of memory addresses designated as being accessible to the secure pipeline and a second set of memory addresses designated as being accessible to the unsecure pipeline and restricts the secure pipeline from accessing memory addresses outside of the first set and the unsecure pipeline from accessing memory addresses outside of the second set. In some embodiments, the memory addresses are stored as virtual to physical address translations (e.g., translations 522, 622, and 722). In some embodiments, the sensor processor circuitry includes a first direct memory access (DMA) engine configured to write the first data set to a portion of memory accessible to the first consumer and a second DMA engine configured to write the second data to another portion of memory accessible to the second consumer.

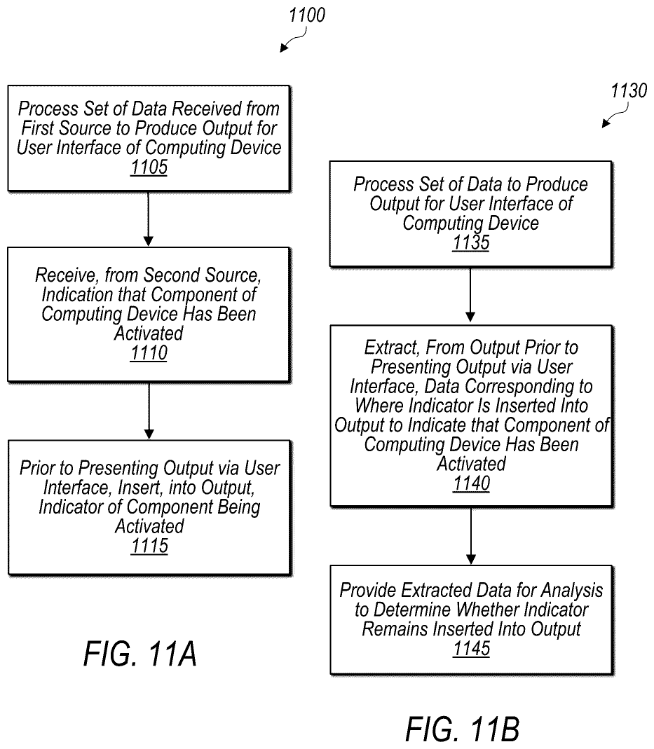

Turning now to FIG. 11A, a flow diagram of a method 1100 is depicted. Method 1100 is one embodiment of a method performed by a computing device including a user interface and user interface pipeline circuitry such as device 10. In many instances, performance of method 1100 can greatly improve the security of the computing device. In some embodiments, method 1100 may be implemented differently than shown.

In step 1105, user interface pipeline circuitry (e.g., a pipeline in display unit 140, audio unit 160, etc.) of the computing device processes a set of data (e.g., input data 402) received from a first source (e.g., a trusted process 112A) to produce an output for the user interface of the computing device. In some embodiments, the user interface pipeline circuitry is display pipeline circuitry (e.g., display pipeline 410) configured to produce frames (e.g., output frame 404) for a display of the computing device. In some embodiments, the user interface pipeline circuitry is an audio pipeline circuitry configured to produce an audio signal for a speaker of the computing device. In some embodiments, the user interface pipeline circuitry is haptic pipeline circuitry configured to produce a haptic feedback data for a haptic feedback engine of the computing device.

In step 1110, the user interface pipeline circuitry receives, from a second source, an indication that a component of the computing device has been activated. In some embodiments, the component is a sensor configured to collect sensitive data about a user, a camera configured to collect image data, or a microphone configure to capture audio data. In some embodiments, the set of data is provided to the user interface pipeline circuitry via a first untrusted process (e.g., an untrusted process 112B) corresponding to the first source; the indication is provided to the user interface pipeline circuitry via a second trusted process corresponding to the second source. In some embodiments, the user interface pipeline circuitry includes a first direct memory access (DMA) engine configured to retrieve the set of data from a memory and a second, different DMA engine (e.g., DMA engine 420) configured to retrieve the indication from the memory.

In step 1115, prior to presenting the output via the user interface, the user interface pipeline circuitry inserts, into the output, an indicator of the component being activated. In some embodiments in which the user interface pipeline circuitry is display pipeline circuitry, the display pipeline circuitry includes a blend pipeline stage (e.g., secure blend 412) configured to insert, based on the received indication, pixel data (e.g., inserted pixel data 414) as the indicator into a frame being rendered by the display pipeline circuitry. In some embodiments in which the user interface pipeline circuitry is an audio pipeline circuitry, the audio pipeline circuitry includes a blend pipeline stage configured to insert, based on the received indication, insert an audio indicator into the audio signal. In some embodiments in which the user interface is a haptic feedback engine, the haptic pipeline circuitry includes a blend pipeline stage configured to insert, based on the received indication, a particular haptic indicator into the haptic feedback data.

In various embodiments, method 1100 further includes extracting data corresponding to where the indicator is inserted into the output to confirm that the indicator remains inserted into the output prior to the output being presented via the user interface. In such an embodiment, the user interface pipeline circuitry may include an extraction stage (e.g., secure extractor 416) configured to extract the data. In some embodiments, program instructions (e.g., a trusted process 112A) receive the extracted data corresponding to where the indicator is inserted into the output and analyze the received extracted data to determine whether the indicator remains inserted into the output. In some embodiments, sensor pipeline circuitry processes data (e.g., sensor data 502) received from the activated component and, in response the indicator remaining inserted into the output, provides the processed data to a destination. In some embodiments, the sensor pipeline circuitry includes a dead man's switch (e.g., cutoff switch 530 or 630) that periodically receives confirmation that the indicator remains inserted into the output and, in response to an omission of the confirmation, interrupts providing the processed data to the destination. In some embodiments, the sensor pipeline circuitry implements an image sensor pipeline (e.g., sensor pipelines 510) configured to process images received from a camera. In some embodiments, the sensor pipeline circuitry implements an audio sensor pipeline (e.g., sensor pipelines 610) configured to process an audio signal received from a microphone.

Turning now to FIG. 11B, a flow diagram of a method 1130 is depicted. Method 1130 is one embodiment of a method performed by a computing device including a user interface and user interface pipeline circuitry such as device 10. In many instances, performance of method 1130 can greatly improve the security of the computing device. In some embodiments, method 1130 may be implemented differently than shown.

Method 1130 begins in step 1135 with user interface pipeline circuitry (e.g., a pipeline in display unit 140, audio unit 160, etc.) of the computing device processing a set of data (e.g., input data 402) to produce an output (e.g., output frame 404) for the user interface (e.g., a display, speaker, etc.) of the computing device. In step 1140, the user interface pipeline circuitry (e.g., via secure extractor 416) extracts, from the output prior to presenting the output via the user interface, data (e.g., extracted pixel data 414) corresponding to where an indicator is inserted into the output to indicate that a component (e.g., a camera, microphone, etc.) of the computing device has been activated. In step 1145, the user interface pipeline circuitry provides the extracted data for analysis to determine whether the indicator remains inserted into the output.

### Exemplary Computer System

Turning now to FIG. 12, a block diagram illustrating an example embodiment of a device 1200 is shown. In some embodiments device 1200 may implement functionality of device 10. In some embodiments, elements of device 1200 may be included within a system on a chip. In some embodiments, device 1200 may be included in a mobile computing device, which may be battery-powered. Therefore, power consumption by device 1200 may be an important design consideration. In the illustrated embodiment, device 1200 includes fabric 102, compute complex 1220 (corresponding to processor 110 in some embodiments), cache/memory controller 1230, display unit 140, ISP 150, audio unit 160, neural engine 170, graphics unit 180, and input/output (I/O) bridge 1260. In some embodiments, device 1200 may include other components (not shown) in addition to or in place of the illustrated components, such as video processor encoders and decoders, image processing or recognition elements, computer vision elements, etc.

Fabric 102 may include various interconnects, buses, MUX's, controllers, etc., and may be configured to facilitate communication between various elements of device 1200. In some embodiments, portions of fabric 102 may be configured to implement various different communication protocols. In other embodiments, fabric 102 may implement a single communication protocol and elements coupled to fabric 102 may convert from the single communication protocol to other communication protocols internally.

In the illustrated embodiment, compute complex 1220 includes bus interface unit (BIU) 1222, cache 1224, and cores 1226A-B. In various embodiments, compute complex 1220 may include various numbers of processors, processor cores and caches. For example, compute complex 1220 may include 1, 2, or 4 processor cores, or any other suitable number. In one embodiment, cache 1224 is a set associative L2 cache. In some embodiments, cores 1226A-B may include internal instruction and data caches. In some embodiments, a coherency unit (not shown) in fabric 102, cache 1224, or elsewhere in device 1200 may be configured to maintain coherency between various caches of device 1200. BIU 1222 may be configured to manage communication between compute complex 1220 and other elements of device 1200. Processor cores such as cores 1226A-B may be configured to execute instructions of a particular instruction set architecture (ISA) which may include operating system instructions and user application instructions. These instructions may be stored in computer readable medium such as a memory coupled to memory controller 1230 discussed below.

As used herein, the term “coupled to” may indicate one or more connections between elements, and a coupling may include intervening elements. For example, in FIG. 12, graphics unit 180 may be described as “coupled to” a memory through fabric 102 and cache/memory controller 1230. In contrast, in the illustrated embodiment of FIG. 12, graphics unit 180 is “directly coupled” to fabric 102 because there are no intervening elements.

Cache/memory controller 1230 may be configured to manage transfer of data between fabric 102 and one or more caches and memories. For example, cache/memory controller 1230 may be coupled to an L3 cache, which may in turn be coupled to a system memory. In other embodiments, cache/memory controller 1230 may be directly coupled to a memory. In some embodiments, cache/memory controller 1230 may include one or more internal caches. Memory coupled to controller 1230 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration.

Memory coupled to controller 1230 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions, such as software blocks from FIGS. 2 and 3A-3C, executable by compute complex 1220 to cause device 1200 to perform functionality described herein.

Graphics unit 180 may include one or more processors, e.g., one or more graphics processing units (GPUs). Graphics unit 180 may receive graphics-oriented instructions, such as OpenGL®, Metal®, or Direct3D® instructions, for example. Graphics unit 180 may execute specialized GPU instructions or perform other operations based on the received graphics-oriented instructions. Graphics unit 180 may generally be configured to process large blocks of data in parallel and may build images in a frame buffer for output to a display, which may be included in the device or may be a separate device. Graphics unit 180 may include transform, lighting, triangle, and rendering engines in one or more graphics processing pipelines. Graphics unit 180 may output pixel information for display images. Graphics unit 180, in various embodiments, may include programmable shader circuitry which may include highly parallel execution cores configured to execute graphics programs, which may include pixel tasks, vertex tasks, and compute tasks (which may or may not be graphics-related).

Display unit 140 may be configured to read data from a frame buffer and provide a stream of pixel values for display. Display unit 140 may be configured as a display pipeline in some embodiments. Additionally, display unit 140 may be configured to blend multiple frames to produce an output frame. Further, display unit 140 may include one or more interfaces (e.g., MIPI® or embedded display port (eDP)) for coupling to a user display (e.g., a touchscreen or an external display).

I/O bridge 1260 may include various elements configured to implement: universal serial bus (USB) communications, security, audio, and low-power always-on functionality, for example. I/O bridge 1260 may also include interfaces such as pulse-width modulation (PWM), general-purpose input/output (GPIO), serial peripheral interface (SPI), and inter-integrated circuit (I2C), for example. Various types of peripherals and devices may be coupled to device 1200 via I/O bridge 1260.

In some embodiments, device 1200 includes network interface circuitry (not explicitly shown), which may be connected to fabric 102 or I/O bridge 1260. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1200 with connectivity to various types of other devices and networks.

### Example Applications

Turning now to FIG. 13, various types of systems that may include any of the circuits, devices, or system discussed above. System or device 1300, which may incorporate or otherwise utilize one or more of the techniques described herein, may be utilized in a wide range of areas. For example, system or device 1300 may be utilized as part of the hardware of systems such as a desktop computer 1310, laptop computer 1320, tablet computer 1330, cellular or mobile phone 1340, or television 1350 (or set-top box coupled to a television).

Similarly, disclosed elements may be utilized in a wearable device 1360, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1300 may also be used in various other contexts. For example, system or device 1300 may be utilized in the context of a server computer system, such as a dedicated server or on shared hardware that implements a cloud-based service 1370. Still further, system or device 1300 may be implemented in a wide range of specialized everyday devices, including devices 1380 commonly found in the home such as refrigerators, thermostats, security cameras, etc. The interconnection of such devices is often referred to as the “Internet of Things” (IoT). Elements may also be implemented in various modes of transportation. For example, system or device 1300 could be employed in the control systems, guidance systems, entertainment systems, etc. of various types of vehicles 1390.

The applications illustrated in FIG. 13 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a computing system configured to generate a simulation model of the hardware circuit, by a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

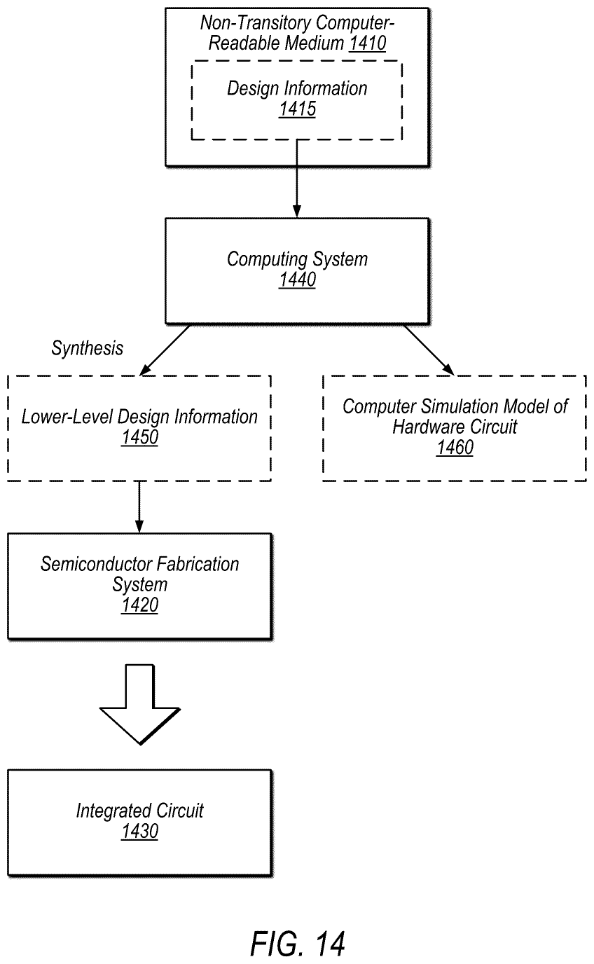

Turning now to FIG. 14, a block diagram of an example non-transitory computer-readable storage medium that stores circuit design information is depicted. In the illustrated embodiment, computing system 1440 is configured to process the design information. This may include executing instructions included in the design information, interpreting instructions included in the design information, compiling, transforming, or otherwise updating the design information, etc. Therefore, the design information controls computing system 1440 (e.g., by programming computing system 1440) to perform various operations discussed below, in some embodiments.

In the illustrated example, computing system 1440 processes the design information to generate both a computer simulation model 1460 of a hardware circuit and lower-level design information 1450. In other embodiments, computing system 1440 may generate only one of these outputs, may generate other outputs based on the design information, or both. Regarding the computing simulation, computing system 1440 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1440 also processes the design information to generate lower-level design information 1450 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1450 (potentially among other inputs), semiconductor fabrication system 1420 is configured to fabricate an integrated circuit 1430 (which may correspond to functionality of the simulation model 1460). Note that computing system 1440 may generate different simulation models based on design information at various levels of description, including information 1450, 1415, and so on. The data representing design information 1450 and model 1460 may be stored on medium 1410 or on one or more other media.

In some embodiments, the lower-level design information 1450 controls (e.g., programs) the semiconductor fabrication system 1420 to fabricate the integrated circuit 1430. Thus, when processed by the fabrication system, the design information may program the fabrication system to fabricate a circuit that includes various circuitry disclosed herein.

Non-transitory computer-readable storage medium 1410, may comprise any of various appropriate types of memory devices or storage devices. Non-transitory computer-readable storage medium 1410 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1410 may include other types of non-transitory memory as well or combinations thereof. Accordingly, non-transitory computer-readable storage medium 1410 may include two or more memory media; such media may reside in different locations—for example, in different computer systems that are connected over a network.

Design information 1415 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1440, semiconductor fabrication system 1420, or both. In some embodiments, design information may also include one or more cell libraries that specify the synthesis, layout, or both of integrated circuit 1430. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1430 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1420 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1420 may also be configured to perform various testing of fabricated circuits for correct operation.

In various embodiments, integrated circuit 1430 and model 1460 are configured to operate according to a circuit design specified by design information 1415, which may include performing any of the functionality described herein. For example, integrated circuit 1430 may include any of various elements shown in FIGS. 1-8. Further, integrated circuit 1430 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1420 to fabricate integrated circuit 1430.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages.

Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A computing device, comprising:
a sensor; and
sensor processor circuitry coupled to the sensor and configured to:
process sensor data received from a sensor of the computing device;
in response to a first indication that a first consumer is trustworthy, provide a first data set of the processed sensor data to the first consumer; and
in response to a second indication that a second consumer is untrustworthy, negotiate one or more conditions in which the second consumer is permitted to receive a second data set of the processed sensor data.

2. The computing device of claim 1, wherein the first indication identifies the first consumer as residing in a secure environment in which a set of security criteria is enforced for the first data set; and
wherein the second indication identifies the second consumer as residing outside of the secure environment.

3. The computing device of claim 2, further comprising:
one or more processors; and
memory having program instructions stored therein that are executable by one or more processors to:
implement a secure execution environment of the secure environment, wherein the first consumer is a first process executing within the secure execution environment, and wherein the second consumer is a second process executing external to the secure execution environment.

4. The computing device of claim 2, wherein the sensor processor circuitry includes:
one or more configuration registers configured to:
store configuration information controlling operation of the sensor, wherein the one or more configuration registers are addressable only by entities within the secure environment.

5. The computing device of claim 1, wherein the sensor processor circuitry is an image signal processor configured to process sensor data received from a camera.

6. The computing device of claim 1, wherein the sensor processor circuitry is an audio processor configured to process sensor data received from a microphone.

7. The computing device of claim 1, wherein the sensor processor circuitry is configured to:
provide an indication that the sensor is active, wherein the one or more conditions include the sensor processor circuitry receiving confirmation that a user is being notified that the sensor is active.

8. The computing device of claim 7, further comprising:
display pipeline circuitry configured to:
in response to the provided indication, insert pixel data in a frame being presented on a display to notify the user is being notified that the sensor is active.

9. The computing device of claim 1, wherein the sensor processor circuitry is configured to:
in response to determining to provide the second data set to the second consumer:
periodically receive a heartbeat signal indicating that the one or more conditions have been satisfied; and
discontinue providing the second data set in response to determining that the heartbeat signal is no longer being received.

10. The computing device of claim 1, wherein the sensor processor circuitry includes:
a switch configured to:
in response to the one or more conditions being violated, interrupt a data path through which the second data set is being provided to the second consumer.

11. The computing device of claim 1, wherein the sensor processor circuitry is configured to:
power gate the sensor in response to determining that the one or more conditions have been violated.

12. The computing device of claim 1, wherein the sensor processor circuitry includes:
a secure pipeline configured to:
process sensor data to produce the first data set for the first consumer; and
an unsecure pipeline configured to:
process sensor data to produce the second data set for the second consumer.

13. The computing device of claim 12, wherein the sensor processor circuitry includes:
an input-output memory management unit (IOMMU) configured to:
store a first set of memory addresses designated as being accessible to the secure pipeline and a second set of memory addresses designated as being accessible to the unsecure pipeline; and
restrict the secure pipeline from accessing memory addresses outside of the first set and the unsecure pipeline from accessing memory addresses outside of the second set.

14. The computing device of claim 13, wherein the memory addresses are stored as virtual to physical address translations.

15. The computing device of claim 1, wherein the sensor processor circuitry includes:
a first direct memory access (DMA) engine configured to write the first data set to a portion of memory accessible to the first consumer; and
a second DMA engine configured to write the second data to another portion of memory accessible to the second consumer.

16. A method, comprising:
processing, by sensor processor circuitry of a computing device, sensor data received from a sensor of the computing device;
in response to a first indication that a first consumer resides in a secure environment, the sensor processor circuitry providing a first data set of the processed sensor data to the first consumer; and
in response to a second indication that a second consumer resides outside of the secure environment, the sensor processor circuitry negotiating one or more conditions in which the second consumer is permitted to receive a second data set of the processed sensor data.

17. The method of claim 16, wherein the negotiated one or more conditions includes a condition that a user is notified about the sensor's use.

18. An integrated circuit, comprising:
one or more processors configured to:
co-execute trusted processes and untrusted processes in an isolated manner that includes enforcing a set of security criteria; and
sensor processor circuitry configured to:
process sensor data received from a sensor;
in response to a first indication that a first process is one of the trusted processes, provide a first data set of the processed sensor data to the first process; and
in response to a second indication that a second process is one of the untrusted processes, restrict, based on one or more of the set of security criteria, access of the second process to a second data set of the processed sensor data.

19. The integrated circuit of claim 18, wherein the sensor processor circuitry includes:
a secure pipeline configured to:
process sensor data to produce the first data set for the first process; and
an input-output memory management unit (IOMMU) configured to:
store a set of memory addresses designated as being accessible to the secure pipeline; and
restrict the secure pipeline from accessing memory addresses outside of the set.

20. The integrated circuit of claim 18, further comprising:
user interface pipeline circuitry configured to:
insert, into an output provided to a user interface, an indicator that the sensor is active; and
wherein the sensor processor circuitry is configured to:
based on the indicator satisfying one or more of the set of security criteria, grant the second process access to the second data set of the processed sensor data.
